(19) United States
(12) Patent Application Publication
(10) Pub. No.: US 2025/0157719 A1
(43) Pub. Date: May 15, 2025

(54) TRANSFORMER APPLIED IN ELECTRIC VEHICLE

(71) Applicant: LITE-ON SINGAPORE PTE. LTD., Singapore (SG)

(72) Inventors: Prasanth THUMMALA, Singapore (SG); Xuan Bac Nguyen, Singapore (SG); Jin Kang Lam, Singapore (SG); Cindy Wan Yi Goh, Singapore (SG)

(21) Appl. No.: 18/596,691

(22) Filed: Mar. 6, 2024

(30) Foreign Application Priority Data
Nov. 9, 2023 (SG) 10202303193X

(51) Int. Cl. H01F 27/28; B60L 53/22; H01F 3/10; H01F 3/14

(52) U.S. Cl. CPC H01F 27/2804; H01F 3/14; B60L 53/22; H01F 2003/106

(57) ABSTRACT

A transformer is provided. The transformer includes a core, a primary winding, and a number of secondary windings. The core has a first leg and a second leg. At least part of the primary winding is wound around the first leg of the core. The primary winding includes a first sub-primary winding. This first sub-primary winding comprises a first auxiliary sub-primary winding and a second auxiliary sub-primary winding. Both the first auxiliary sub-primary winding and the second auxiliary sub-primary winding are bifilar wound, and they are connected in parallel. Some of the secondary windings are wound around the first leg of the core, and some of the secondary windings are wound around the second leg of the core.

This application claims the benefit of Singapore provisional application Ser. No. 10/202,303193X, filed Nov. 9, 2023, the disclosure of which is incorporated by reference herein in its entirety.

### TECHNICAL FIELD

The disclosure relates to a transformer applied in charging batteries of electric vehicle (EV) and electrical devices or equipment used in vehicle simultaneously.

### BACKGROUND

International efforts to reduce global warming have begun, and the development of propulsion electric vehicles has made significant progress toward eliminating fuel consumption. The charging equipment industry is keenly observing the trend toward vehicle electrification and actively establishing an increased number of charging stations across the country, including home charging facilities, to facilitate electric vehicle charging. Transformers play a crucial role in transferring primary power from the grid to battery banks for recharging the electric vehicles at these charging stations or home charging points. To enhance battery charging efficiency across various voltage levels, specialized transformers designed for efficient charging are essential.

### SUMMARY

According to one embodiment, a transformer is provided. The transformer includes a core, a primary winding, and a number of secondary windings. The core has a first leg and a second leg. At least part of the primary winding is wound around the first leg of the core. The primary winding includes a first sub-primary winding. The first sub-primary winding comprises a first auxiliary sub-primary winding and a second auxiliary sub-primary winding. Both the first auxiliary sub-primary winding and the second auxiliary sub-primary winding are bifilar wound, and they are connected in parallel. Some of the secondary windings are wound around the first leg of the core, while other secondary windings are wound around the second leg of the core.

### BRIEF DESCRIPTION OF THE DRAWINGS

FIG. 1 shows a circuit diagram of a transformer according to an embodiment of the disclosure.

FIG. 2A shows a core of the transformer in FIG. 1.

FIG. 2B shows the schematic diagram of the transformer in FIG. 1.

FIG. 2C and FIG. 2D shows part of the transformer in FIG. 2B.

FIG. 2E shows another core of the transformer in FIG. 1 according to another embodiment of the disclosure.

FIG. 3 shows the sectional view of the transformer along the section line 3A-3B in FIG. 2B.

FIG. 4A shows the circuit diagram of the transformer with nodes n1 to n10a corresponding to the circuit diagram of the transformer in FIG. 1.

FIG. 4B shows the sectional view of the transformer with terminations N1 to N9a corresponding to the sectional view of the transformer in FIG. 3.

FIG. 5A shows a front view of a transformer according to an embodiment of the disclosure.

FIG. 5B shows a rear view of the transformer of FIG. 5A.

FIG. 5C shows a side view of the transformer of FIG. 5A.

FIG. 5D shows the schematic view of one of the metal slots (which is solid or flexible) in the transformer from FIG. 5A to FIG. 5C.

FIG. 6 shows an example of various test conditions when the transformer in FIG. 1 operates in forward mode.

FIG. 7 shows an example of various test conditions when the transformer in FIG. 1 operates in reverse mode.

FIG. 8A shows a circuit diagram of a transformer according to another embodiment of the disclosure.

FIG. 8B shows the sectional view of the transformer in FIG. 8A.

FIG. 9A shows a circuit diagram of a transformer according to another embodiment of the disclosure.

FIG. 9B shows the sectional view of the transformer in FIG. 9A.

In the following detailed description, for purposes of explanation, numerous specific details are set forth to provide a thorough understanding of the disclosed embodiments. However, it will be apparent that one or more embodiments may be practiced without these specific details. In other instances, well-known structures and devices are schematically shown in order to simplify the drawings.

### DETAILED DESCRIPTION

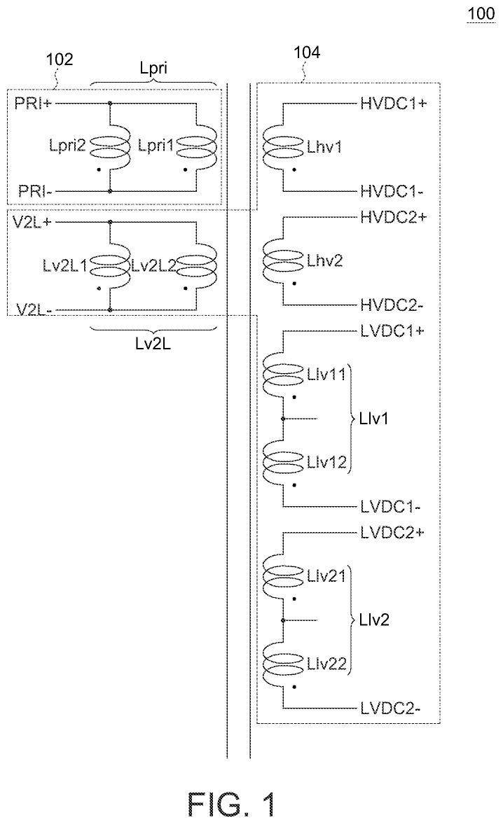

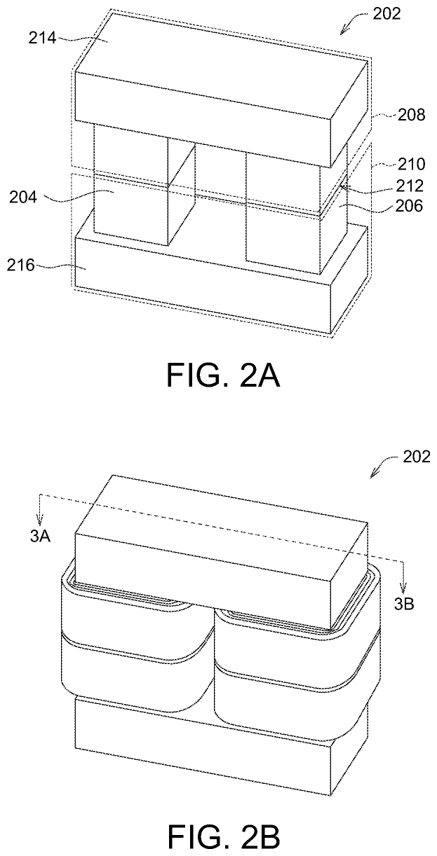

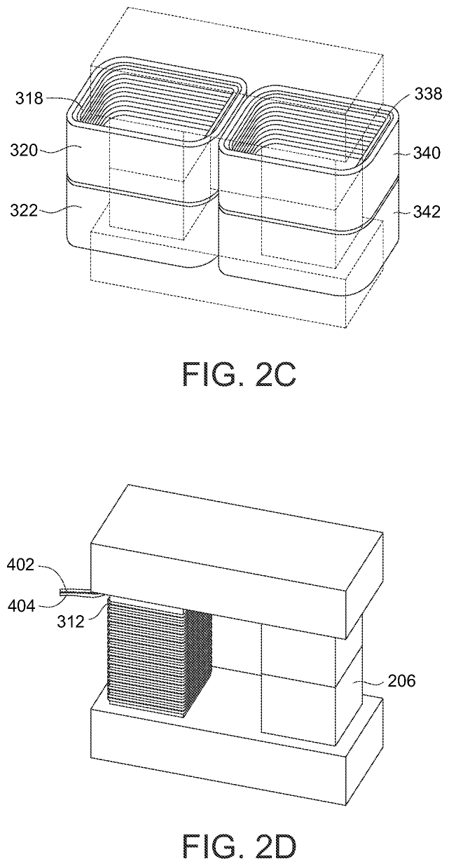

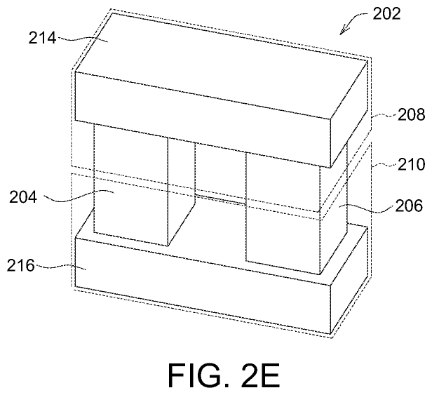

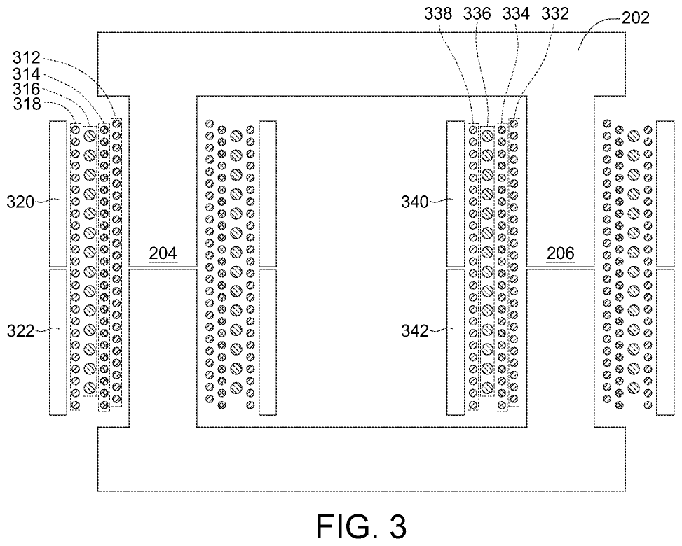

Referring to FIG. 1, FIG. 2A to FIG. 2D, and FIG. 3, where FIG. 1 shows a circuit diagram of the transformer according to an embodiment of the disclosure, FIG. 2A shows the core of the transformer in FIG. 1, FIG. 2B shows the schematic diagram of the transformer in FIG. 1, FIG. 2C and FIG. 2D show part of the transformer in FIG. 2B, and FIG. 3 shows the sectional view of the transformer along the section line 3A-3B in FIG. 2B. The transformer 100 comprises a core 202, a primary winding 102, and a number of secondary windings 104. The core 202 has a first leg 204 and a second leg 206. At least part of the primary winding 102 is wound around the first leg 204 of the core 202. The primary winding 102 (or primary winding Lpri) includes a first sub-primary winding, Lpri1, comprising a first auxiliary sub-primary winding, Lpri11, and a second auxiliary sub-primary winding, Lpri12, both of which are bifilar wound and connected in parallel. Some of the secondary windings 104 are wound around the first leg 204 of the core 202, and some of the secondary windings 104 are wound around the second leg 206 of the core 202.

The primary winding 102 can also include a second sub-primary winding Lpri2, comprising a third auxiliary sub-primary winding, Lpri21, and a fourth auxiliary sub-primary winding, Lpri22. Both auxiliary sub-primary windings, Lpri21 and Lpri22, are bifilar wound and connected in parallel. The first sub-primary winding, Lpri1, is wound around the first leg 204 of the core 202, and the second sub-primary winding, Lpri2, is wound around the second leg 206 of the core 202. Nodes PRI+ and PRI− are connected to two ends of the first sub-primary winding, Lpri1, and two ends of the second sub-primary winding, Lpri2. The transformer 202 can be used for charging batteries of electric vehicles (EV) and charging electrical devices or equipment used in the vehicle simultaneously.

Referring to FIG. 3, the first sub-primary winding Lpri1, comprising the first auxiliary sub-primary winding Lpri11 and the second auxiliary sub-primary winding Lpri12, is formed in the first coil layer 312 and the fourth coil layer 318 for the first leg 204, for example. Each coil layer includes a certain number of turns. Since the first auxiliary sub-primary winding Lpri11 and the second auxiliary sub-primary winding Lpri12 are bifilar wound, half of the turns in the first coil layer 312 are used by the first auxiliary sub-primary winding Lpri11, and the other half by the second auxiliary sub-primary winding Lpri12. Similarly, half of the turns in the fourth coil layer 318 are used by the first auxiliary sub-primary winding Lpri11, and the other half by the second auxiliary sub-primary winding Lpri12. For instance, the odd turns in the first coil layer 312 belong to the first auxiliary sub-primary winding Lpri11, while the even turns belong to the second auxiliary sub-primary winding Lpri12.

The second sub-primary winding Lpri2, comprising the third auxiliary sub-primary winding Lpri21 and the fourth auxiliary sub-primary winding Lpri22, is formed in the first coil layer 332 and the fourth coil layer 338 for the second leg 206, for example. Each of these coil layers includes a certain number of turns. Since the third auxiliary sub-primary winding Lpri21 and the fourth auxiliary sub-primary winding Lpri22 are bifilar wound, half of the turns of the first coil layer 332 are assigned to the third auxiliary sub-primary winding Lpri21, while the other half are assigned to the fourth auxiliary sub-primary winding Lpri22. Likewise, half of the turns in the fourth coil layer 338 belong to the third auxiliary sub-primary winding Lpri21, and the remaining half belong to the fourth auxiliary sub-primary winding Lpri22. For instance, the odd turns in the first coil layer 332 belong to the third auxiliary sub-primary winding Lpri21, while the even turns belong to the fourth auxiliary sub-primary winding Lpri22.

The secondary windings, such as the first high voltage secondary winding Lhv1 and the first low voltage secondary winding Llv1, are wound around the core 202. At least part of the first high voltage secondary winding Lhv1 is wound around the first leg 204 of the core 202, and similarly, at least part of the first low voltage secondary winding Llv1 is wound around the first leg 204 of the core 202.

In addition, the secondary windings 104 further include a second high voltage secondary winding Lhv2 and a second low voltage secondary winding Llv2. The first high voltage secondary winding Lhv1 is wound around the first leg 204 of the core 202, while the second high voltage secondary winding Lhv2 is wound around the second leg 206 of the core 202. The first low voltage secondary winding Llv1 is wound around the first leg 204 of the core 202, and the second low voltage secondary winding Llv2 is wound around the second leg 206 of the core 202.

The first high voltage secondary winding Lhv1 is located in the third coil layer 316 for the first leg 204, for example. This coil layer includes a certain number of turns specifically assigned to the first high voltage secondary winding Lhv1. Similarly, the second high voltage secondary winding Lhv2 is located in the third coil layer 336 for the second leg 206, for example, also including a certain number of turns specifically assigned for the second high voltage secondary winding Lhv2. The first high voltage secondary winding Lhv1 outputs AC power through nodes HVDC1+ and HVDC1−, while the second high voltage secondary winding Lhv2 outputs AC power through nodes HVDC2+ and HVDC2−.

The first low voltage secondary winding Llv1 includes a series connection of a first sub low voltage secondary winding Llv11 and a second sub low voltage secondary winding Llv12. Likewise, the second low voltage secondary winding Llv2 includes a series connection of a third sub low voltage secondary winding Llv21 and a fourth sub low voltage secondary winding Llv22. The first low voltage secondary winding Llv1 provides AC power through nodes LVDC1+ and LVDC1−, while the second low voltage secondary winding Llv2 provides AC power through nodes LVDC2+ and LVDC2−.

The first sub low voltage secondary winding Llv11 is created using a metal slot 320 that is placed outside the fourth coil layer 318. Similarly, the second sub low voltage secondary winding Llv12 is created using a metal slot 322 placed outside the fourth coil layer 318. Therefore, both the first and second sub low voltage secondary windings (Llv11 and Llv12) are located on the outer side of the first sub-primary winding Lpri1.

Similarly, the third sub low voltage secondary winding Llv21 and the fourth sub low voltage secondary winding Llv22 are created using metal slots 340 and 342, both of which are placed outside the fourth coil layer 338. These two sub low voltage secondary windings (Llv21 and Llv22) are located on the outer side of the second sub-primary winding Lpri2. Due to the larger cross-sectional area of the metal slots 320, 322, 340, and 342, when compared to other winding wires, these sub windings can accommodate larger currents.

Referring to both FIG. 1 and FIG. 3, we observe that among the secondary windings, there's a Vehicle-to-Load (V2L) secondary winding Lv2L. This winding is at least partially wound around the first leg 204 of the core 202. The V2L secondary winding Lv2L itself includes a first sub V2L secondary winding Lv2L1, which in turn comprises a first auxiliary sub V2L secondary winding Lv2L11 and a second auxiliary sub V2L secondary winding Lv2L12. These two auxiliary sub windings are bifilar wound and connected in parallel to one another.

The V2L secondary winding Lv2L further includes a second sub V2L secondary winding Lv2L2. The second sub V2L secondary winding Lv2L2 comprises a third auxiliary sub V2L secondary winding Lv2L21 and a fourth auxiliary sub V2L secondary winding Lv2L22. These two auxiliary sub windings are bifilar wound and connected in parallel. The first sub V2L secondary winding Lv2L1 is wound around the first leg 204 of the core 202, and the second sub V2L secondary winding Lv2L2 is wound around the second leg 206 of the core 202. The V2L secondary winding Lv2L outputs AC power through nodes V2L+ and V2L−.

The first sub V2L secondary winding Lv2L1, which includes the first auxiliary sub V2L secondary winding Lv2L11 and the second auxiliary sub V2L secondary winding Lv2L12, is formed in the second coil layer 314 for the first leg 204, for example. The second coil layer 314 has a number of turns of winding. Since the first auxiliary sub V2L secondary winding Lv2L11 and the second auxiliary sub V2L secondary winding Lv2L12 are bifilar wound, half of the turns of the second coil layer 314 belong to the first auxiliary sub V2L secondary winding Lv2L11, while the other half belong to the second auxiliary sub V2L secondary winding Lv2L12. For example, the odd turns of the second coil layer 314 correspond to the turns of the first auxiliary sub V2L secondary winding Lv2L11, and the even turns of the second coil layer 314 correspond to the turns of the second auxiliary sub V2L secondary winding Lv2L12.

The second sub V2L secondary winding Lv2L2, which includes the third auxiliary sub V2L secondary winding Lv2L21 and the fourth auxiliary sub V2L secondary winding Lv2L22, is formed in the second coil layer 334 for the second leg 206, for example. The second coil layer 334 has a number of turns of winding. Since the third auxiliary sub V2L secondary winding Lv2L21 and the fourth auxiliary sub V2L secondary winding Lv2L22 are bifilar wound, half of the turns of the second coil layer 334 belong to the third auxiliary sub V2L secondary winding Lv2L21, and the other half belong to the fourth auxiliary sub V2L secondary winding Lv2L22. For example, the odd turns of the second coil layer 334 correspond to the turns of the third auxiliary sub V2L secondary winding Lv2L21, while the even turns of the second coil layer 334 correspond to the turns of the fourth auxiliary sub V2L secondary winding Lv2L22.

As shown in FIG. 2A, the core 202 includes a first dual T structure 208 and a second dual T structure 210. The first dual T structure 208 faces the second dual T structure 210. An air-gap 212 exists between the first dual T structure 208 and the second dual T structure 210, and the core 202 is made of ferrite.

In addition, in another embodiment, there is no air-gap between the first dual T structure 208 and the second dual T structure 210. As shown in FIG. 2E, which shows another core of the transformer in FIG. 1 according to another embodiment of the disclosure, part of the core 202 is made of ferrite, and the first leg 204 and the second leg 206 are made of iron powder. For example, part 214 and part 216 of the core 202 are made of ferrite. In this design, there is no air-gap between the first dual T structure 208 and the second dual T structure 210.

In FIG. 2C, the fourth coil layers 318 and 338, and the metal slots 320, 322, 340, 342 are shown. The metal slots 320 and 322 cover the fourth coil layer 318, and the metal slots 340 and 342 cover the fourth coil layer 338. In FIG. 2D, the first coil layer 312 wound around the first leg 204 is shown. Since the first auxiliary sub-primary winding Lpri11 and the second auxiliary sub-primary winding Lpri12 are bifilar wound to form the first coil layer 312, two wires (including wire 402 and 404) are used to wind on the first leg 204 to form the first coil layer 312.

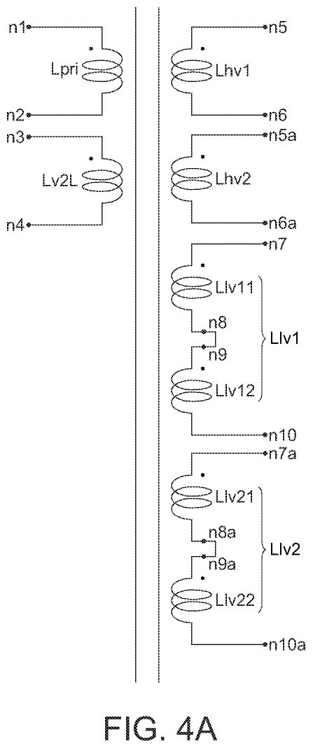

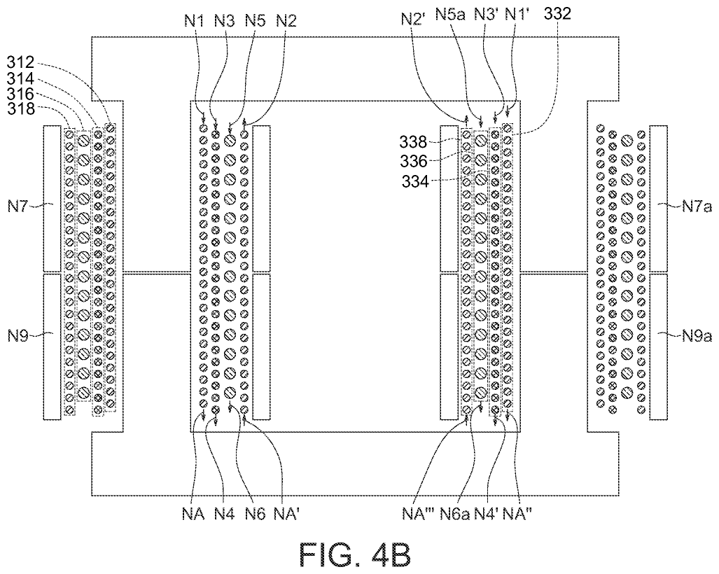

Referring to FIG. 4A and FIG. 4B, FIG. 4A shows the circuit diagram of the transformer with nodes of primary and secondary windings n1 to n10a, corresponding to the circuit diagram of the transformer of FIG. 1, and FIG. 4B shows the sectional view of the transformer with winding terminations N1 to N9a corresponding to the sectional view of the transformer in FIG. 3. The direction of the arrows in FIG. 4B represents the winding direction of the wires for the windings. The nodes n1 to n9a correspond to the terminations N1 to N9a.

For the first coil layer 312, a first wire and a second wire are wound from termination N1 to termination NA. Then, a third wire and a fourth wire are wound from termination N3 to termination N4 to form the second coil layer 314, and a fifth wire is wound from termination N5 to termination N6 to form the third coil layer 316. After that, the first wire and the second wire are continuously wound from termination NA′, which is connected to termination NA, to termination N2 to form the fourth coil layer 318.

Similarly, for the first coil layer 332, a sixth wire and a seventh wire are wound from termination N1′ to termination NA″ in the reverse direction to that of first and second wires in coil layer 312. Then, an eighth wire and a ninth wire are wound from termination N3′ to termination N4′ in the reverse direction to that of third and fourth wires in coil layer 314 to form the second coil layer 334, and a tenth wire is wound from termination N5a to termination N6a in the reverse direction to that of fifth wire in coil layer 316 to form the third coil layer 336. After that, the sixth wire and the seventh wire are continuously wound from termination NA′″, which is connected to termination NA″, to termination N2′ in the reverse direction to that of first and second wires in coil layer 318 to form the fourth coil layer 338. For example, when wires in the first leg are wound in clockwise direction, the wires in the second legs will be wound in anti-clockwise direction. The terminations N1 and N1′ are electrically connected, the terminations N2 and N2′ are electrically connected, the terminations N3 and N3′ are electrically connected, and the terminations N4 and N4′ are electrically connected.

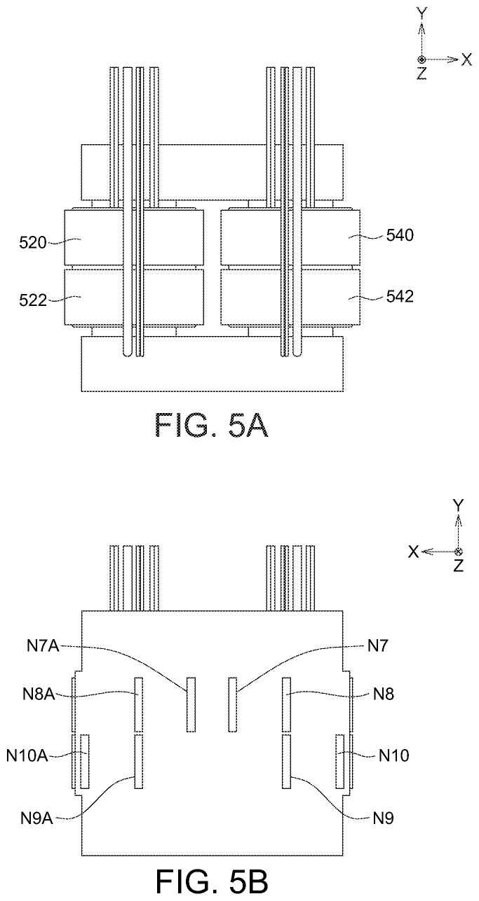

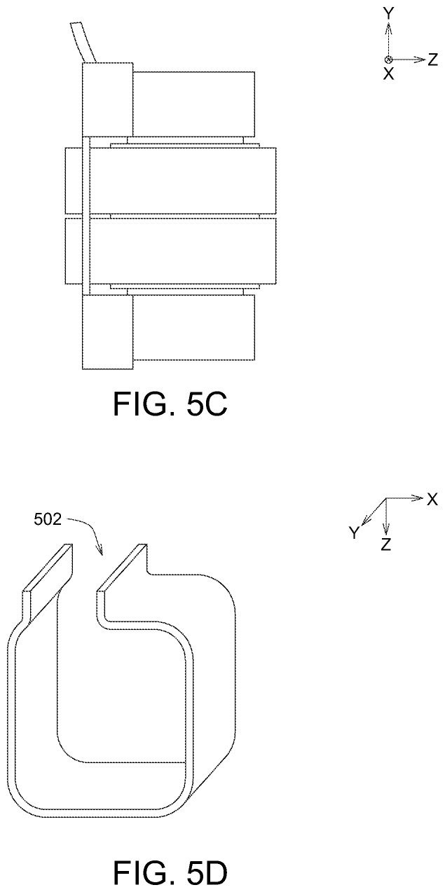

Referring to FIG. 5A to FIG. 5D, FIG. 5A shows a front view of the transformer according to an embodiment of the disclosure, FIG. 5B shows a rear view of the transformer of FIG. 5A, FIG. 5C shows a side view of the transformer of FIG. 5A, and FIG. 5D shows the schematic view of one of the metal slots in the transformer from FIG. 5A to FIG. 5C. The difference between the transformer in FIG. 1 to FIG. 3 and the transformer in FIG. 5A to FIG. 5D lies in the fact that each of the first sub low voltage secondary winding to the fourth sub low voltage secondary winding, which is implemented by a metal slot, has an opening 502. One termination N8 of the first sub low voltage secondary winding 520 is electrically connected to one termination N9 of the second sub low voltage secondary winding 522. One termination N8A of the third sub low voltage secondary winding 540 is electrically connected to one termination N9A of the fourth sub low voltage secondary winding 542.

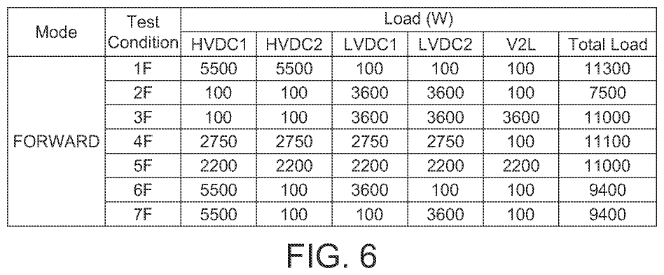

Referring to FIG. 6, it shows an example of various test conditions when the transformer in FIG. 1 operates in forward mode. When the transformer 100 operates in forward mode, AC power is supplied to the primary winding 102, which induces AC power in the secondary winding 104. FIG. 6 illustrates different test conditions, including test conditions 1F to 7F, for example. In test condition 1F, AC power is delivered to nodes HVDC1+ and HVDC1−, as well as nodes HVDC2+ and HVDC2−, for example, to charge the high voltage batteries of the EV. In test condition 2F, AC power is delivered to nodes LVDC1+ and LVDC1−, as well as nodes LVDC2+ and LVDC2−, for example, to charge the low voltage batteries of the EV. In test condition 3F, AC power is delivered to nodes LVDC1+ and LVDC1−, as well as nodes LVDC2+ and LVDC2−, for charging the low voltage batteries of the EV, additionally, AC power is provided to nodes V2L+ and V2L−, enabling other electrical devices or equipment (for example, laptop, microphone, and so on) within the EV.

In test condition 4F, AC power is delivered to nodes HVDC1+ and HVDC1−, nodes HVDC2+ and HVDC2−, nodes LVDC1+ and LVDC1−, and nodes LVDC2+ and LVDC2− to charge the high voltage and low voltage batteries of the electric vehicle (EV), respectively. In test condition 5F, AC power is delivered to nodes HVDC1+ and HVDC1−, nodes HVDC2+ and HVDC2−, nodes LVDC1+ and LVDC1−, nodes LVDC2+ and LVDC2−, and nodes V2L+ and V2L−. In test condition 6F, AC power is delivered to nodes HVDC1+ and HVDC1− and nodes LVDC1+ and LVDC1−. In test condition 7F, AC power is delivered to nodes HVDC1+ and HVDC1− and nodes LVDC2+ and LVDC2−.

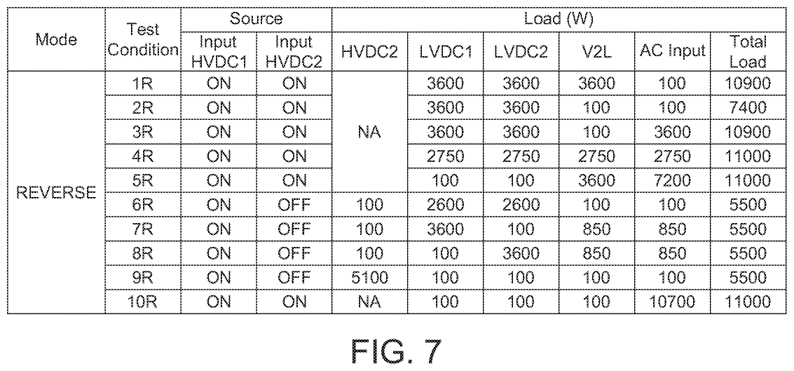

Referring to FIG. 7, it shows an example of various test conditions when the transformer in FIG. 1 operates in reverse mode. When the transformer 100 operates in reverse mode, AC power is supplied to nodes HVDC1+ and HVDC1−, and/or nodes HVDC2+ and HVDC2− in the secondary winding 104, which induces AC power in the primary winding 102 or other nodes in the secondary winding 104. FIG. 7 illustrates different test conditions, including test conditions 1R to 10R, for example.

In test condition 1R, AC power is supplied to nodes HVDC1+ and HVDC1−, and nodes HVDC2+ and HVDC2−, and then delivered to nodes LVDC1+ and LVDC1−, nodes LVDC2+ and LVDC2−, and nodes V2L+ and V2L−. In test condition 2R, AC power is supplied to nodes HVDC1+ and HVDC1−, and nodes HVDC2+ and HVDC2−, and delivered to nodes LVDC1+ and LVDC1−, and nodes LVDC2+ and LVDC2−. In test condition 3R, AC power is supplied to nodes HVDC1+ and HVDC1−, and nodes HVDC2+ and HVDC2−, and delivered to nodes LVDC1+ and LVDC1−, nodes LVDC2+ and LVDC2−, and the AC input (for example, grid, through nodes PRI+ and PRI−).

In test condition 4R, AC power is supplied to nodes HVDC1+ and HVDC1−, and nodes HVDC2+ and HVDC2−, and delivered to nodes LVDC1+ and LVDC1−, nodes LVDC2+ and LVDC2−, nodes V2L+ and V2L−, and the AC input (for example, the grid, through nodes PRI+ and PRI−). In test condition 5R, AC power is supplied to nodes HVDC1+ and HVDC1−, and nodes HVDC2+ and HVDC2−, and delivered to nodes V2L+ and V2L−, and the AC input.

In test condition 6R, AC power is supplied to nodes HVDC1+ and HVDC1−, and delivered to nodes LVDC1+ and LVDC1−, nodes LVDC2+ and LVDC2−. In test condition 7R, AC power is supplied to nodes HVDC1+ and HVDC1−, and delivered to nodes LVDC1+ and LVDC1−, nodes V2L+ and V2L−, and AC input. In test condition 8R, AC power is supplied to nodes HVDC1+ and HVDC1−, and delivered to nodes LVDC2+ and LVDC2−, nodes V2L+ and V2L−, and AC input.

In test condition 9R, AC power is supplied to nodes HVDC1+ and HVDC1−, and delivered to nodes HVDC2+ and HVDC2−. In test condition 10R, AC power is supplied to nodes HVDC1+ and HVDC1−, and nodes HVDC2+ and HVDC2−, and delivered to the AC input.

Since the transformer according to the embodiment of the disclosure has multiple output ports integrated within a single core, it can charge several batteries and/or to provide charging power to multiple electrical devices simultaneously. This design offers a cost-effective solution, as only one core is required for the output ports, unlike the conventional approach that uses five transformers with individual cores for HVDC1, HVDC2, LVDC1, LVDC2, and V2L output ports. The transformer, as described in the embodiment of the disclosure, can independently charge several loads with high efficiency and low cost by utilizing a single core.

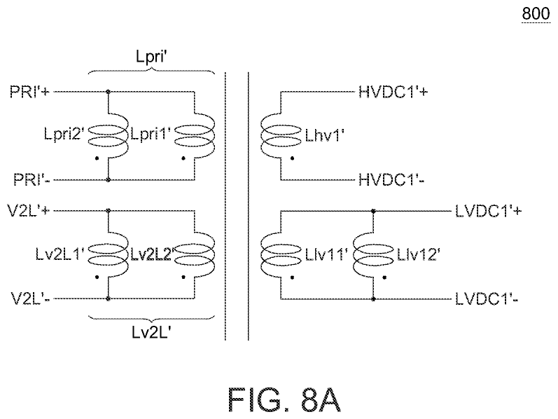

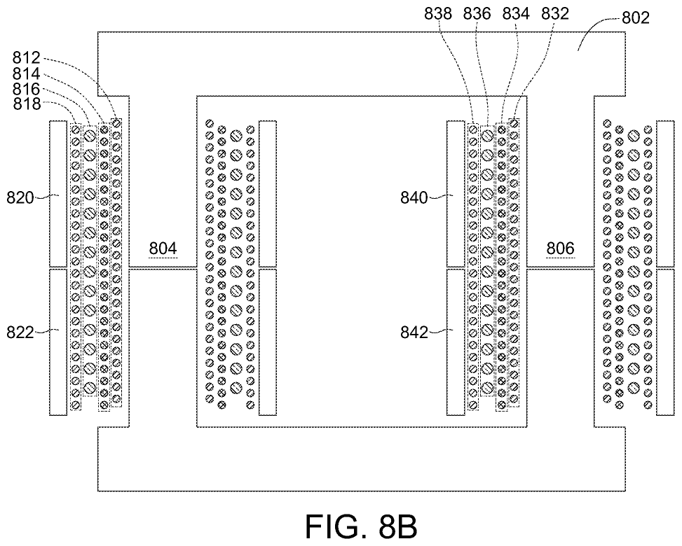

Referring to FIG. 8A and FIG. 8B, FIG. 8A shows a circuit diagram of a transformer according to another embodiment of the disclosure, while FIG. 8B illustrates the sectional view of the transformer in FIG. 8A. As shown in FIG. 8A, the transformer 800 has an input port (designated as nodes PRI′+ and PRI′−) and several output ports (identified as nodes HVDC1′+ and HVDC1′−, nodes LVDC1′+ and LVDC1′−, and nodes V2L′+ and V2L′−).

Referring to FIG. 8B, the primary winding Lpri′ includes a first sub-primary winding Lpri1′ and a second sub-primary winding Lpri2′. The first sub-primary winding Lpri1′, which incorporates a first auxiliary sub-primary winding Lpri11′ and a second auxiliary sub-primary winding Lpri12′, is formed in the first coil layer 812 and the fourth coil layer 818, and is wound around the first leg 804 of the core 802, for example. The first auxiliary sub-primary winding Lpri11′ and the second auxiliary sub-primary winding Lpri12′ are bifilar wound and connected in parallel. The second sub-primary winding Lpri2′, comprising a third auxiliary sub-primary winding Lpri21′ and a fourth auxiliary sub-primary winding Lpri22′, is formed in the first coil layer 832 and the fourth coil layer 838, and is wound around the second leg 806 of the core 802, for example. The third auxiliary sub-primary winding Lpri21′ and the fourth auxiliary sub-primary winding Lpri22′ are bifilar wound and connected in parallel.

The first high voltage secondary winding Lhv1′ includes a first sub high voltage secondary winding Lhv11′ and a second sub high voltage secondary winding Lhv12′. Lhv11′ is wound around the first leg 804 of the core 802 and is formed in the third coil layer 816. Similarly, Lhv12′ is wound around the second leg 806 of the core 802 and is formed in the third coil layer 836. Both Lhv11′ and Lhv12′ are connected in parallel.

The first low voltage secondary winding Llv1′ comprises a first sub low voltage secondary winding Llv11′ and a second sub low voltage secondary winding Llv12′. Llv11′ is wound around the first leg 804 of the core 802, while Llv12′ is wound around the second leg 806 of the core 802. Llv11′ is implemented using metal slots 820 and 822, which are connected in series to create a center-tap. Similarly, Llv12′ is implemented by metal slots 840 and 842, also connected in series to create a center-tap. Both Llv11′ and Llv12′ are connected in parallel.

The V2L secondary winding Lv2L′ includes a first sub V2L secondary winding Lv2L1′ and a second sub V2L secondary winding Lv2L2′. The first sub V2L secondary winding Lv2L1′ includes a first auxiliary sub V2L secondary winding Lv2L11′ and a second auxiliary sub V2L secondary winding Lv2L12′. These auxiliary sub V2L secondary windings, Lv2L11′ and Lv2L12′ are bifilar wound in the second coil layer 814 and connected in parallel.

The second sub V2L secondary winding Lv2L2′ includes a third auxiliary sub V2L secondary winding Lv2L21′ and a fourth auxiliary sub V2L secondary winding Lv2L22′. These auxiliary sub V2L secondary windings Lv2L21′ and Lv2L22′ are bifilar wound in the second coil layer 834 and connected in parallel.

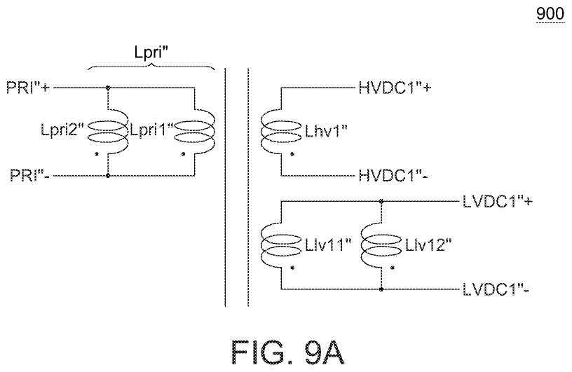

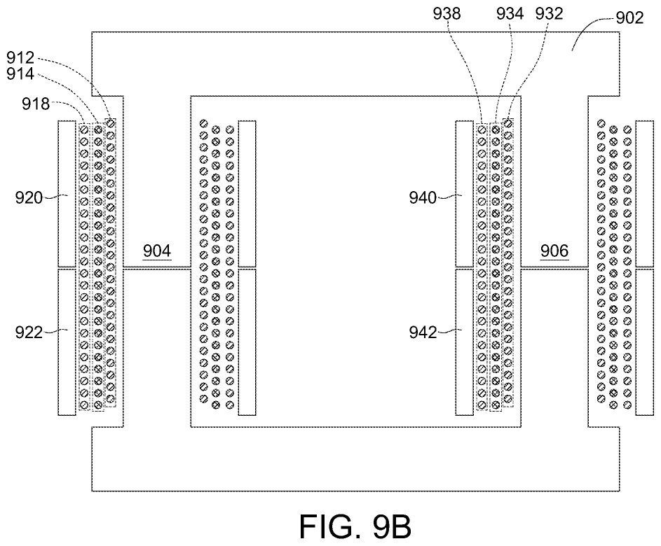

Referring to FIG. 9A and FIG. 9B, FIG. 9A illustrates a circuit diagram of a transformer according to another embodiment of the disclosure, while FIG. 9B depicts the sectional view of the transformer shown in FIG. 9A. In FIG. 9A, the transformer 900 features an input port (labeled as nodes PRI″+ and PRI″−) as well as output ports (labeled as nodes HVDC1″+ and HVDC1″− and nodes LVDC1″+ and LVDC1″−).

Referring to FIG. 9B, the primary winding Lpri″ includes a first sub-primary winding Lpri1″ and a second sub-primary winding Lpri2″. The first sub-primary winding Lpri1″, which includes a first auxiliary sub-primary winding Lpri11″ and a second auxiliary sub-primary winding Lpri12″, is formed in the first coil layer 912 and the third coil layer 918, and is wound around the first leg 904 of the core 902, for example. The first auxiliary sub-primary winding Lpri11″ and the second auxiliary sub-primary winding Lpri12″ are bifilar wound and connected in parallel. The second sub-primary winding Lpri2″, which includes a third auxiliary sub-primary winding Lpri21″ and a fourth auxiliary sub-primary winding Lpri22″, is formed in the first coil layer 932 and the third coil layer 938, and is wound around the second leg 906 of the core 902, for example. The third auxiliary sub-primary winding Lpri21″ and the fourth auxiliary sub-primary winding Lpri22″ are bifilar wound and connected in parallel.

The first high voltage secondary winding Lhv1″ comprises a first sub high voltage secondary winding Lhv11″ and a second sub high voltage secondary winding Lhv12″. Lhv11″ is wound around the first leg 904 of the core 902 and is formed in the second coil layer 914. Meanwhile, Lhv12″ is wound around the second leg 906 of the core 902 and is formed in the second coil layer 934. Both Lhv11″ and Lhv12″ are connected in parallel.

The first low voltage secondary winding Llv1″ includes a first sub low voltage secondary winding Llv11″ and a second sub low voltage secondary winding Llv12″. Llv11″ is wound around the first leg 904 of the core 902, and Llv12″ is wound around the second leg 906 of the core 902. Additionally, Llv11″ is implemented using metal slots 920 and 922, which are connected in series to create a center-tap. Similarly, Llv12″ is implemented using metal slots 940 and 942, also connected in series to create a center-tap. Both Llv11″ and Llv12″ are connected in parallel.

The transformer according to the embodiment of the disclosure, features multiple output ports connected to a single core. This transformer can simultaneously charge several batteries and/or provide charging power to multiple loads or electrical devices. Notably, it achieves this with high efficiency and low cost. Each load can be charged independently, making it a practical solution for various applications.

It will be apparent to those skilled in the art that various modifications and variations can be made to the disclosed embodiments. It is intended that the specification and examples should be considered as exemplars only, with the true scope of the disclosure being indicated by the following claims and their equivalents.

What is claimed is:

1. A transformer, comprising:
a core, having a first leg and a second leg;
a primary winding, wherein at least part of the primary winding is wound around the first leg of the core, the primary winding includes a first sub-primary winding, the first sub-primary winding comprises a first auxiliary sub-primary winding and a second auxiliary sub-primary winding, the first auxiliary sub-primary winding and the second auxiliary sub-primary winding are bifilar wound and connected in parallel; and
a plurality of secondary windings, some of the secondary windings are wound around the first leg of the core, and the other secondary windings are wound around the second leg of the core.

2. The transformer according to claim 1, the primary winding further includes a second sub-primary winding, the second sub-primary winding comprises a third auxiliary sub-primary winding and a fourth auxiliary sub-primary winding, the third auxiliary sub-primary winding and the fourth auxiliary sub-primary winding are bifilar wound and connected in parallel, the first sub-primary winding is wound around the first leg of the core, the second sub-primary winding is wound around the second leg of the core.

3. The transformer according to claim 1, wherein the secondary windings comprise a first high voltage secondary winding and a first low voltage secondary winding, at least part of the first high voltage secondary winding is wound around the first leg of the core, while at least part of the first low voltage secondary winding is wound around the first leg of the core.

4. The transformer according to claim 3, wherein the secondary windings further comprise a second high voltage secondary winding and a second low voltage secondary winding, the first high voltage secondary winding is wound around the first leg of the core, the second high voltage secondary winding is wound around the second leg of the core, the first low voltage secondary winding is wound around the first leg of the core, and the second low voltage secondary winding is wound around the second leg of the core.

5. The transformer according to claim 4, wherein the first low voltage secondary winding includes a first sub low voltage secondary winding and a second sub low voltage secondary winding connected in series, and the second low voltage secondary winding includes a third sub low voltage secondary winding and a fourth sub low voltage secondary winding also connected in series.

6. The transformer according to claim 5, wherein each of the first sub low voltage secondary winding to the fourth sub low voltage secondary winding, each implemented by a metal slot, the first sub low voltage secondary winding and the second sub low voltage secondary winding are disposed on the outer side of the first sub-primary winding, the third sub low voltage secondary winding and the fourth sub low voltage secondary winding are disposed on the outer side of the second sub-primary winding.

7. The transformer according to claim 6, wherein each of the first sub low voltage secondary winding through the fourth sub low voltage secondary winding includes an opening, one termination of the first sub low voltage secondary winding is electrically connected to one termination of the second sub low voltage secondary winding, and one termination of the third sub low voltage secondary winding is electrically connected to one termination of the fourth sub low voltage secondary winding.

8. The transformer according to claim 6, the metal slot is solid or flexible.

9. The transformer according to claim 3, wherein the first high voltage secondary winding comprises a first sub high voltage secondary winding and a second sub high voltage secondary winding, the first sub high voltage secondary winding is wound around the first leg of the core, while the second sub high voltage secondary winding is wound around the second leg of the core, the first sub high voltage secondary winding and the second sub high voltage secondary winding are connected in parallel.

10. The transformer according to claim 3, wherein the first low voltage secondary winding comprises a first sub low voltage secondary winding and a second sub low voltage secondary winding, the first sub low voltage secondary winding is wound around the first leg of the core, and the second sub low voltage secondary winding is wound around the second leg of the core, the first sub low voltage secondary winding and the second sub low voltage secondary winding are connected in parallel.

11. The transformer according to claim 1, wherein the secondary windings comprise a Vehicle-to-Load (V2L) secondary winding, at least part of the V2L secondary winding is wound around the first leg of the core, the V2L secondary winding comprises a first sub V2L secondary winding, the first sub V2L secondary winding comprises a first auxiliary sub V2L secondary winding and a second auxiliary sub V2L secondary winding, the first auxiliary sub V2L secondary winding and the second auxiliary sub V2L secondary winding are bifilar wound and connected in parallel.

12. The transformer according to claim 11, the V2L secondary winding further comprises a second sub V2L secondary winding, the second sub V2L secondary winding comprises a third auxiliary sub V2L secondary winding and a fourth auxiliary sub V2L secondary winding, the third auxiliary sub V2L secondary winding and the fourth auxiliary sub V2L secondary winding are bifilar wound and connected in parallel, the first sub V2L secondary winding is wound around the first leg of the core, the second sub V2L secondary winding is wound around the second leg of the core.

13. The transformer according to claim 1, wherein the core comprises a first dual T structure and a second dual T structure, the first dual T structure faces the second dual T structure.

14. The transformer according to claim 13, wherein an air-gap exists between the first dual T structure and the second dual T structure, and the core is made of ferrite.

15. The transformer according to claim 13, wherein there is no air-gap between the first dual T structure and the second dual T structure, part of the core is made of ferrite, and the first leg and the second leg is made of iron powder.
